(19) United States
(12) Patent Application Publication
(10) Pub. No.: US 2019/0009338 A1
(43) Pub. Date: Jan. 10, 2019

(54) POWDER BED FUSION APPARATUS AND METHODS

(71) Applicant: RENISHAW PLC, Wotton-under-Edge, Gloucestershire (GB)

(72) Inventors: David Roberts MCMURTRY, Dursley (GB); Geoffrey MCFARLAND, Wickwar (GB); Liam David HALL, Longniddry (GB); Christopher John SUTCLIFFE, Liverpool (GB); Robin Geoffrey WESTON, Alsager (GB)

(73) Assignee: RENISHAW PLC, Wotton-under-Edge, Gloucestershire (GB)

(21) Appl. No.: 16/069,991

(22) PCT Filed: Jan. 10, 2017
(86) PCT No.: PCT/GB2017/050046

§ 371 Date: Jul. 13, 2018

(30) Foreign Application Priority Data
Jan. 13, 2016 (GB) 1600629.8

(51) Int. Cl. B22F 3/105; B33Y 30/00; B33Y 10/00

(52) U.S. Cl. CPC B22F 3/1055; B22F 2003/1056; B33Y 10/00; B33Y 30/00

(57) ABSTRACT

A powder bed fusion apparatus in which selected areas of a powder bed are solidified in a layer-by-layer manner to form a workpiece, the powder bed fusion apparatus including a build chamber for maintaining an inert atmosphere or (partial) vacuum, a build sleeve located within the build chamber, a build platform for supporting the powder bed movable in the build sleeve, a powder applicator for forming powder layers of the powder bed and a radiation device for generating and steering a radiation beam across a surface of the powder bed to solidify areas of each layer, wherein the build sleeve is mounted in the build chamber to be tiltable to cause displacement of powder from the build sleeve through an opening in the build sleeve.

### FIELD OF INVENTION

This invention concerns powder bed fusion apparatus and methods in which selected areas of a powder bed are solidified in a layer-by-layer manner to form a workpiece. The invention has particular, but not exclusive application, to selective laser melting (SLM) and selective laser sintering (SLS) apparatus.

### BACKGROUND

Powder bed fusion apparatus produce objects through layer-by-layer solidification of a material, such as a metal powder material, using a high energy beam, such as a laser or electron beam. A powder layer is formed across a powder bed contained in a build sleeve by lowering a build platform to lower the powder bed, depositing a heap of powder adjacent to the lowered powder bed and spreading the heap of powder with a wiper across (from one side to another side of) the powder bed to form the layer. Portions of the powder layer corresponding to a cross-section of the workpiece to be formed are then solidified through irradiating these areas with the beam. The beam melts or sinters the powder to form a solidified layer. After selective solidification of a layer, the powder bed is lowered by a thickness of the newly solidified layer and a further layer of powder is spread over the surface and solidified, as required. An example of such a device is disclosed in U.S. Pat. No. 6,042,774.

A problem with such powder bed fusion apparatus is how to extract the workpiece from the powder bed after completion of the build. In particular, it is desirable to extract the workpiece and recover the unsolidified powder without exposing the unsolidified powder to an atmosphere having a high oxygen concentration, for example air, such that the recovered powder can be used for a subsequent build. It is known, for example, from EP1793979 to provide a glove box and suction nozzle to allow a user to separate the powder from the workpiece before the workpiece is removed from the powder bed fusion apparatus. A problem with such an apparatus is that is requires manual intervention. It is desirable to provide an apparatus that can separate the workpiece from the powder without manual intervention.

It is known from US2004/0084814 and US 2007/0026145 to provide one or more gas inlet(s) and gas outlet(s) to the build sleeve to provide a flow of gas through the build sleeve for forcing powder from the build sleeve. US2004/0084814 further discloses a vibration generator operably secured to the build sleeve such that, when activated, the vibration generator vibrates the build sleeve to loosen unbound powder within the build sleeve. The vibration generator may be operated during the removal of unbound powder.

US2008/0241404 describes apparatus comprising a build platform of the build sleeve having collapsible or removable parts capable of releasing unused powder directly from the build sleeve in a downward direction under the force of gravity. Such as system is particularly unsuitable for use with metal powder as a workpiece built from metal powder typically must be secured to a solid substrate plate, for example as described in U.S. Pat. No. 5,753,274.

Other systems separate the powder from the workpiece at a location different to that in which the workpiece is built. US2007/0001342 and WO2015/071184 disclose the removal of the building sleeve from the selective laser melting apparatus to a separate station in which the powder is separated from the workpiece. US2007/0001342 describes a station comprising a tilting device with which the removed build sleeve is tilted so that raising of a carrier pushes powder over an overflow edge for collection. WO2015/071184 discloses a station in which the removed build sleeve is rotated through an angle of at least 90 degrees from an upright position.

DE102011002954 and US2001/0045678 discloses apparatus for transferring the workpiece and powder bed to a powder removal station. US2001/0045678 discloses transferring the workpiece to the powder removal station through an opening in the build sleeve. DE102011002954 discloses raising the build platform such that the workpiece is elevated above the build sleeve and then using a feed device for pushing the workpiece and powder cake into a filter device.

US2015/0224718 discloses an additive manufacturing apparatus comprising a build sleeve oriented such that movement of a conveyor belt moves the material bed in a horizontal direction to allow the formation of additional layers of the material bed. The build sleeve has a slanted opening such that layers of the material bed are formed at an angle, the angle selected in such a way that it is smaller than a specific angle of repose of the particulate material.

### SUMMARY OF INVENTION

According to a first aspect of the invention there is provided a powder bed fusion apparatus in which selected areas of a powder bed are solidified in a layer-by-layer manner to form a workpiece, the powder bed fusion apparatus comprising a build chamber for maintaining an inert atmosphere or (partial) vacuum, a build sleeve located within the build chamber, a build platform for supporting the powder bed movable in the build sleeve, a powder applicator for forming powder layers of the powder bed and a radiation device for generating and steering a radiation beam across a surface of the powder bed to solidify areas of each layer, wherein the build sleeve is mounted in the build chamber to be tiltable to cause displacement of powder from the build sleeve through an opening in the build sleeve.

The opening may be at least one aperture in a wall of the build sleeve separate from an opening in a top of the build sleeve across which layers are formed by the applicator, the at least one aperture located in the build sleeve such that, when the build sleeve is tilted, material falls from the build sleeve through the aperture. The aperture may be located in a lower portion of the build sleeve and opened to the powder bed such that powder can flow therethrough when the build platform has moved past the aperture on completion of the build. Alternatively, a movable barrier may be provided for closing the aperture, the barrier arranged to move to open the aperture when the build sleeve is tilted. In a further embodiment, the aperture is arranged such that the aperture is angled upwards towards an outside of the build sleeve when the build sleeve is in a position in which the workpiece is built, the aperture angled downwards when the build sleeve is tilted to allow flow of powder therefrom.

The opening may be an opening in a top of the build sleeve across which layers are formed by the applicator.

The mounting of the build sleeve may allow the build sleeve to be tilted such that the opening faces downwards. The build sleeve may be mounted to be rotatable by greater than 90 degrees. The build sleeve may be rotatable substantially about a centre of the build sleeve. In particular, an axis of rotation of the build sleeve may be such that, during rotation, the build sleeve at least in part stays within a footprint of the build sleeve when positioned for the build of the workpiece.

The apparatus may further comprise a controller for controlling movement of the build platform and tilting of the build sleeve such that the build platform is driven upwards when the build sleeve is tilted such that powder exits the build sleeve from the opening. The build sleeve may be tilted by an angle such that the opening is at an angle greater than a critical angle of repose of the powder. Alternatively, the build sleeve may be tilted by an angle such that the opening is at an angle smaller than a critical angle of repose of the powder and the apparatus further comprises a vibration mechanism for vibrating the build sleeve/build platform to cause collapse of powder at the opening when the build sleeve is tilted. The apparatus may comprise a controller for controlling movement of the build platform and vibration mechanism such that the build platform is driven upwards in conjunction with vibrating the build sleeve/build platform such that powder falls from the build sleeve.

According to a second aspect of the invention there is provided a powder bed fusion apparatus in which selected areas of a powder bed are solidified in a layer-by-layer manner to form a workpiece, the powder bed fusion apparatus comprising a build chamber for maintaining an inert atmosphere or (partial) vacuum, a build sleeve located within the build chamber, a build platform movable in the build sleeve, the build platform for supporting a powder bed, a powder applicator for forming powder layers of the powder bed, a radiation device for generating and steering a radiation beam across a surface of the powder bed to solidify areas of each layer, wherein an opening of the build sleeve, across which layers of powder are formed by the applicator, is tilted at an angle to the horizontal that is smaller than a critical angle of repose of the powder, the apparatus further comprising a vibration mechanism for vibrating the build sleeve/build platform to cause collapse of powder at the opening and a controller for controlling movement of the build platform and the vibration mechanism such that the build platform is driven upwards in conjunction with vibrating the build sleeve/build platform such that powder falls from the build sleeve.

According to a third aspect of the invention there is provided a powder bed fusion apparatus in which selected areas of a powder bed are solidified in a layer-by-layer manner to form a workpiece, the powder bed fusion apparatus comprising a build chamber for maintaining an inert atmosphere or (partial) vacuum, a build sleeve located within the build chamber, a build platform movable in the build sleeve, the build platform for supporting a powder bed, a powder applicator for forming powder layers of the powder bed, a radiation device for generating and steering a radiation beam across a surface of the powder bed to solidify areas of each layer, an outlet in a wall of the build sleeve and a vibration mechanism for vibrating the powder such that an acoustic radiation force alone or in combination with an asymmetric geometry of the build sleeve/build platform about a central axis of the build sleeve causes preferential movement of the powder to a side of the build sleeve comprising the outlet.

The vibration mechanism may be located in a side wall of the build sleeve opposite the outlet to generate an acoustic radiation force on the powder in a direction across the build sleeve from the vibration mechanism to the outlet.

The build sleeve may comprise a circumferential passageway therein for receiving powder when the build platform has been lowered to a specific point in the build sleeve at the end of the build, the build passageway connected with the outlet and angled such that the vibrations move the particles along the passageway towards the outlet.

The build platform may comprise a mechanism for mounting a build substrate thereon such that the build substrate can tilt relative to the build platform to provide directionality to powder movement when the powder is vibrated. The build platform may comprise supports that engage the build substrate and can be moved to alter and hold the build substrate in different positions.

According to a fourth aspect of the invention there is provided a powder bed fusion apparatus in which selected areas of a powder bed are solidified in a layer-by-layer manner to form a workpiece, the powder bed fusion apparatus comprising a build chamber for maintaining an inert atmosphere or (partial) vacuum, a build sleeve located within the build chamber, a build platform movable in the build sleeve, the build platform for supporting a powder bed, a powder applicator for forming powder layers of the powder bed, a radiation device for generating and steering a radiation beam across a surface of the powder bed to solidify areas of each layer, and a controller for controlling movement of the build platform and the vibration mechanism such that the build platform is driven upwards and/or located at the top of the build sleeve and in conjunction with vibrating the build sleeve/build platform such that an acoustic radiation force causes movement of the powder to outside a build sleeve footprint.

Optionally, the controller is configured to tilt the build platform relative to the build sleeve.

Optionally, the controller is configured to raise the build platform to a level where substantially all the powder may be moved to outside a build sleeve footprint by passing over a top of the build sleeve.

According to a fifth aspect of the invention there is provided a powder bed fusion apparatus in which selected areas of a powder bed are solidified in a layer-by-layer manner to form a workpiece, the powder bed fusion apparatus comprising a build chamber for maintaining an inert atmosphere or (partial) vacuum, a build sleeve located within the build chamber, a build platform movable in the build sleeve, the build platform for supporting a powder bed, a powder applicator for forming powder layers of the powder bed, a radiation device for generating and steering a radiation beam across a surface of the powder bed to solidify areas of each layer, the apparatus further comprising a controller for controlling movement of the build platform such that the build platform is driven upwards and/or located at the top of the build sleeve and the build platform is tilted with respect to the build sleeve such that the powder is caused to move outside a build sleeve footprint.

Optionally, the controller is configured to raise the build platform to a level where substantially all the powder may be moved to outside a build sleeve footprint by passing over a top of the build sleeve.

The apparatus of the first, second, third, fourth and fifth aspects of the invention provide means for removing powder from the build sleeve within the inert atmosphere or (partial) vacuum of the build chamber without the complexity of introducing gas flow though the build sleeve.

The build platform may have a circular cross-section and mounted for rotation about its centre. The apparatus may comprise a motor for driving rotation of the build platform. The controller may rotate the build platform during removal of powder from the build sleeve using the mechanisms of the first, second or third aspects of the invention. Rotation of the build platform can allow powder that is trapped in recesses in the workpiece against the direction of the applied force (gravity and/or the acoustic waves) in one orientation of the build platform to be moved to another position in which the powder is free to move from the recesses under the action of the applied force.

The build sleeve may be arranged such that powder leaving the build sleeve through the opening/outlet remains within the inert atmosphere or (partial) vacuum maintained by the build chamber. The powder may pass into a further compartment in the build chamber or into a container outside of the build chamber that is also subject to the inert atmosphere or partial vacuum.

According to a sixth aspect of the invention there is provided a method of removing powder from a build sleeve of a powder bed fusion apparatus comprising a build chamber for maintaining an inert atmosphere or (partial) vacuum, a build sleeve located within the build chamber, a build platform for supporting the powder bed movable in the build sleeve, a powder applicator for forming powder layers of the powder bed and a radiation device for generating and steering a radiation beam across a surface of the powder bed to solidify areas of each layer, the method comprising tilting the build sleeve within the build chamber and/or vibrating the build cylinder and/or build platform to apply a force that causes the powder to preferentially move towards an opening in the build sleeve.

### DESCRIPTION OF THE DRAWINGS

FIG. 1 is a schematic view of a powder bed fusion apparatus according to an embodiment of the invention;

FIG. 2 is a perspective view of the build sleeve and build platform of the powder bed fusion apparatus shown in FIG. 1;

FIG. 3 is a cross-sectional view of the build sleeve and build platform shown in FIG. 2 tilted for the release of powder from the build sleeve;

FIG. 4 is a perspective view of a powder bed fusion apparatus according to another embodiment of the invention comprising a rotatable build sleeve;

FIG. 5 is a cross-sectional view of the powder bed fusion apparatus shown in FIG. 4 wherein the build sleeve has been rotated to release powder from the build sleeve;

FIG. 6 is a cross-sectional view of a powder bed fusion apparatus according to yet another embodiment of the invention comprising a tilted build sleeve and vibrating mechanism;

FIG. 7 is a cross-sectional view of a powder bed fusion apparatus according to a further embodiment of the invention;

FIG. 8 is a perspective view of a powder bed fusion apparatus according to a still further embodiment of the invention comprising a channel in an inner side wall of the build sleeve; and

FIG. 9 is a perspective view of a powder bed fusion apparatus according to another embodiment of the invention comprising a build sleeve rotatable about two perpendicular axis B-B and C-C;

FIG. 10 is a cross-sectional view of a powder bed fusion apparatus according to a yet further embodiment of the invention.

### DESCRIPTION OF EMBODIMENTS

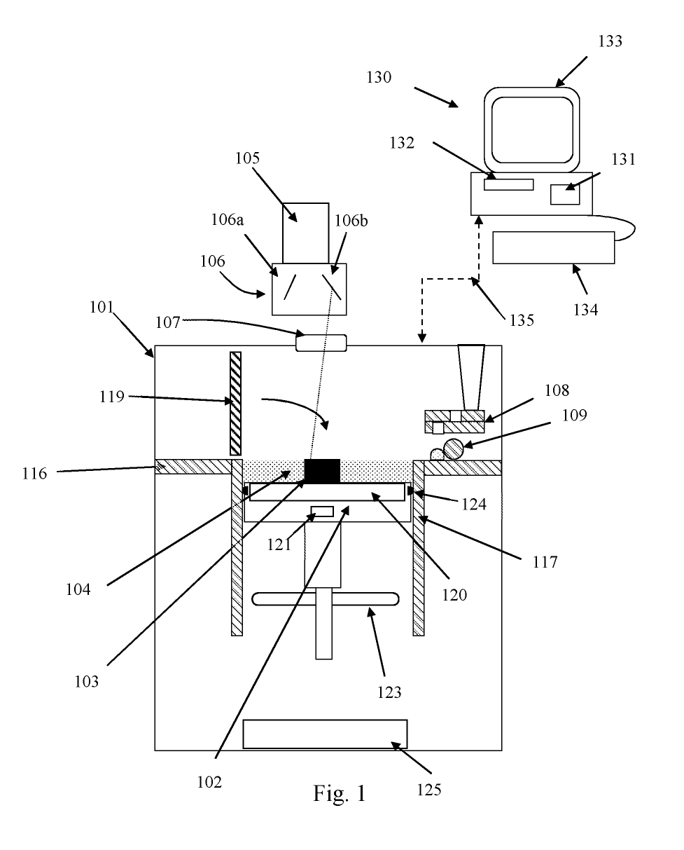

Referring to FIGS. 1 to 3, a powder bed fusion apparatus according to an embodiment of the invention comprises a build chamber 101 having a build sleeve 117 and a build plate 116, which surrounds the build sleeve 117. The build sleeve 117 is mounted to the plate 116 via a hinge 118 such that the build sleeve 117 can be titled below the plate 116. Movement of the build sleeve 117 about a pivot point of the hinge 118 is driven by a motor 122.

The build sleeve 117 has outwardly extending flanges 114a, 114b at a top thereof having formation 113a, 113b capable of being engaged with an under-surface of the plate 116 to locate the build sleeve 117 in a position in which a build of a workpiece can be carried out. An aperture 123 is provided in a side wall of the build sleeve 117. In this embodiment, the aperture 123 is an elongate aperture extending across a majority of the width of a side wall of a rectangular cross-section of the build sleeve 117.

A lid 119 can be placed over the build sleeve 117 and secured thereto to prevent powder from exiting via opening 115 when the build sleeve 117 is tilted.

The build platform 102 is provided for supporting a powder bed 104 and workpiece 103 built by the selective laser melting of powder layers of bed 104. The platform 102 can be lowered within the build sleeve 117 as successive layers of the workpiece 103 are formed. Seal 124 ensures that the powder remains in build sleeve 117 during the build. The build platform 102 further comprises a circular table 120 that can be rotated about axis A-A under the control of motor 121.

Layers of powder of bed 104 are formed as the workpiece 103 is built by dispensing apparatus 108 and an elongate wiper 109. For example, the dispensing apparatus 108 may be apparatus as described in WO2010/007396. In particular, the build platform 102 is lowered by a set amount and powder dispensed onto an upper surface of plate 116 is spread across an opening 115 in the top of the build sleeve 117 to form a layer having a thickness as defined by the set amount that the build platform 102 has moved down.

A laser module 105 generates a laser beam for melting the powder 104, the laser directed as required by optical scanner 106 under the control of a computer 130. The laser enters the chamber 101 via a window 107.

The optical scanner 106 comprises steering optics, in this embodiment, two movable mirrors 106a, 106b for directing the laser beam to the desired location on the powder bed 104 and focussing optics, in this embodiment a pair of movable lenses (not shown) for adjusting a focal length of the laser beam. Motors (not shown) drive movement of the mirrors 106a, 106b and lenses.

Computer 130 comprises the processor unit 131, memory 132, display 133, user input device 134, such as a keyboard, touch screen, etc., a data connection 135 to modules of the laser melting unit, such as optical module 106 and laser module 105, dispensing apparatus 108, motors for driving the wiper 109 and build platform 102 and motors 121 and 122. Stored on memory 132 is a computer program, which, when executed by the processing unit 131 causes the processing unit 131 to control the modules of the powder bed fusion apparatus to build a workpiece.

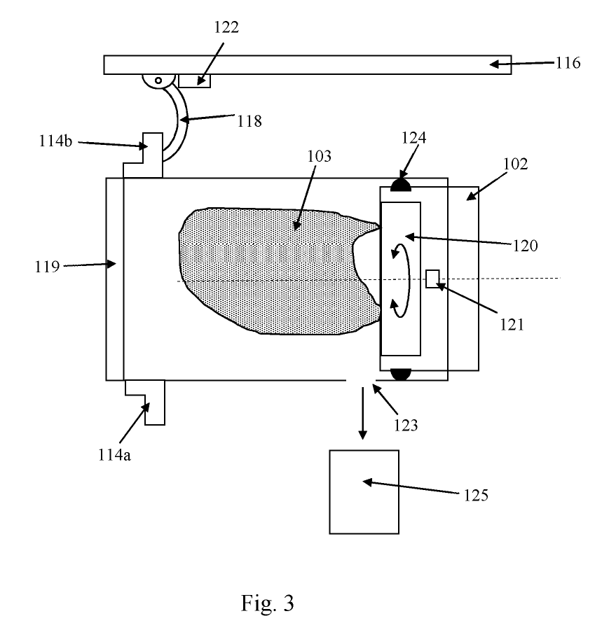

At the end of the build, lid 119 is placed over the opening 115 in the build sleeve 117, for example manually through a glove box or automatically by an electro-mechanical mechanism under the control of computer 130. The build sleeve 117 is then tilted to the position shown in FIG. 3 under the control of motor 122. In this position, the build platform 102 is driven further along build sleeve 117 such that the seal 124 moves past the aperture 123 allowing powder to exit the build sleeve 117 via aperture 123. To facilitate removal of powder from the workpiece 103, table 120 is rotated to rotate the workpiece 103, which is attached thereto, such that powder initially trapped in upwardly facing surfaces of the workpiece 103 is released by turning such faces downwards.

The powder exiting aperture 123 is collected in powder recovery hopper 125. A transport system (not shown) may be provided for automating the transfer of recovered powder in powder recovery hopper 125 to the dispense hopper of dispensing apparatus 108.

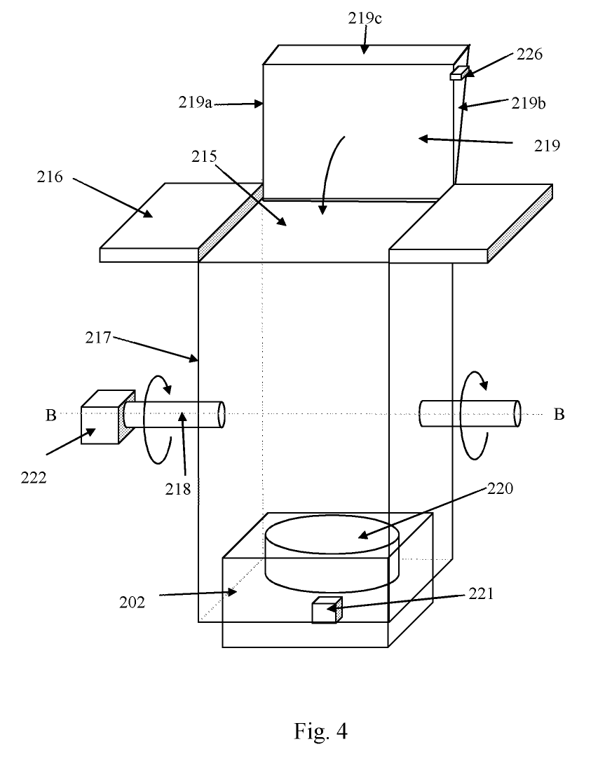

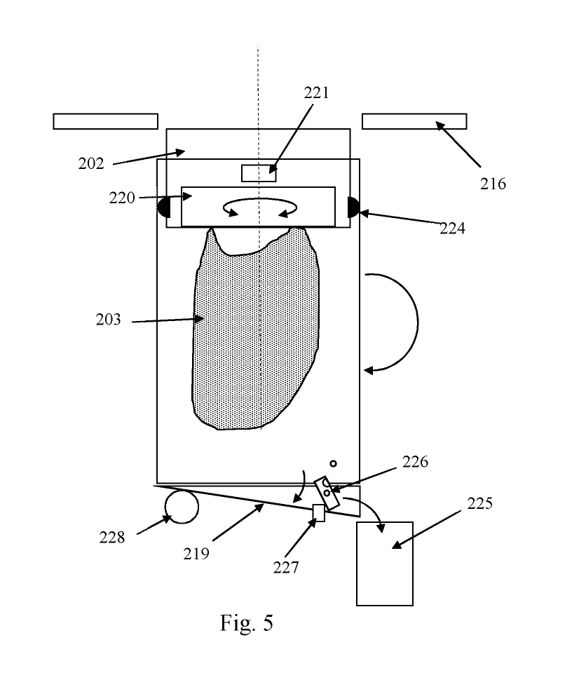

Referring to FIGS. 4 and 5 a further embodiment of the invention is shown. In this embodiment, like reference numerals but in the series 200 are used for features of this embodiment that correspond to features of the embodiment shown in FIGS. 1 to 3. In this embodiment, the build sleeve 217 is mounted on shaft 218 for rotation about axis B-B under the control of motor 222. Lid 219 has triangular shaped sides 219a, 219b, an open side 219c and latching mechanism 226.

In use, after the end of a build of a workpiece 203, the lid 219 is placed over opening 215 of the build sleeve 217 with the sides 219a to 219c received in the build sleeve 217 such that the opening 215 is sealed against the flow of powder therefrom. The lid 219 is held in this position by the latching mechanism 226, for example, a catch that holds the lid 219 in place against biasing of a spring. The build sleeve 217 is rotated to the position shown in FIG. 5, whereupon the catch is released, for example through engagement with a release mechanism 227, such as an abutment, such that the lid 219 moves to a position as shown in FIG. 5 under the biasing provided by the spring. In this position, powder can flow from build sleeve 117 out through opening 219c into a powder recovery hopper 225. To facilitate powder recovery, the rotary table 220 is rotated by motor 221. A mechanism, such as cam 228, is located for engaging the lid 219 upon further rotation of the build sleeve 217 to close the lid 219. The build sleeve 217 may be rotated a number of times to the position shown in FIG. 5 to release powder from the workpiece 203 and build sleeve 217.

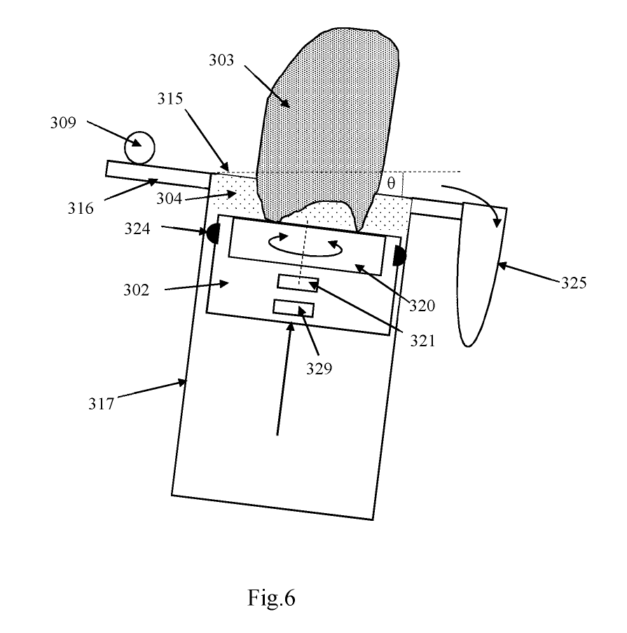

Referring to FIG. 6, a further embodiment of the invention is shown. In this embodiment, like reference numerals but in the series 300 are used for features of this embodiment that correspond to features of the embodiments shown in FIGS. 1 to 5. In this embodiment, the build sleeve 317 is fixed in place within the build chamber such that planar opening 315 is at an angle, θ, to the horizontal. The angle θ is selected to be less than the critical angle of repose of the powder. In this way, layers of powder can be formed in a conventional manner without collapse of the layer. An ultrasonic vibrating mechanism 329 is provided in the build platform 302.

At the end of the build, the build platform 302 is slowly raised and the vibrating mechanism 329 activated. This causes collapse of the powder at opening 315 such that the powder falls under gravity off the edge of plate 316 into a powder recovery hopper 325. The powder recovery hopper 325 may be the same hopper as used to capture excess powder spread during layer formation. During raising of the build platform 302, the table 320 is rotated to release powder from recesses in the workpiece 303. The wiper 309 may be used to push any powder that remains on the plate 316 into the powder recovery hopper 325.

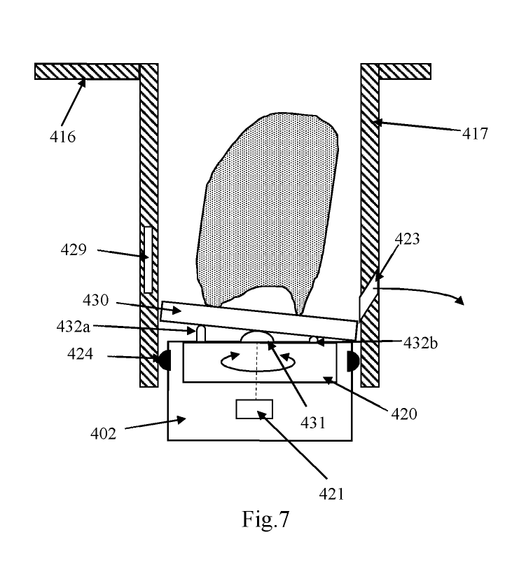

Referring to FIG. 7, a further embodiment of the invention is shown. In this embodiment, like reference numerals but in the series 400 are used for features of this embodiment that correspond to features of the embodiments shown in FIGS. 1 to 6. In this embodiment, aperture 423 comprises a passageway that extends upwardly from an internal surface of the build sleeve 417 wall to an external surface of the build sleeve 417 wall. An ultrasonic vibrating mechanism 429 is provided in an opposed wall of the build sleeve 417.

The build platform 402 comprises a tilting mechanism to which a build plate 430 is mounted that allows tilting of the build substrate 430 about a horizontal axis. The mechanism comprises a bearing, such as a spherical plain bearing 431, to which the build substrate 430 is mounted that allows titling of the build substrate 430 in any direction about the bearing 431 whilst ensuring that the build substrate 430 rotates with the rotary table 420. The titling mechanism further comprises three positioning supports (only two 432a, 432b of which are shown) that engage a lower surface of the build substrate 430 and can be actuated to protrude by a distance from the build platform 402 to set a position of the build substrate 430. The use of three positioning supports allows the build substrate 430 to be adjusted to and maintained in a continuum of tilted positions about the rotary axis of bearing 431. Variations in the distances the three positioning mechanisms 432a, 432b protrude from the build platform 402 tilt the build substrate 430 in a desired direction.

At the end of a build, the build platform is lowered such that the seal 424 passes aperture 423, the vibrating mechanism 429 activated and the build substrate tilted towards the aperture 423. The location of the source of the vibrations and the tilt of the build substrate 430 encourages the vibrating powder to move towards the aperture 423. The vibrations are sufficient to cause the powder to flow up and out from aperture 423 into a powder recovery hopper (not shown). During powder removal, the table 420 can be rotated, rotating build substrate 430. During the rotation of the table 420, the tilt position of the build substrate 430 is adjusted to maintain the tilt towards the aperture 423.

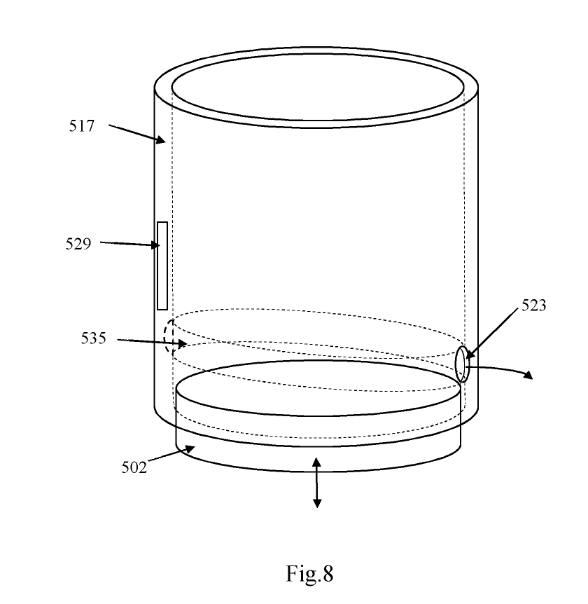

Referring to FIG. 8, a further embodiment of the invention is shown. In this embodiment, like reference numerals but in the series 500 are used for features of this embodiment that correspond to features of the embodiments shown in FIGS. 1 to 7. In this embodiment, the build sleeve 517 is a cylinder having an aperture 523. An internal channel 535, open to the internal volume enclosed by the build sleeve 517, extends around the wall of the build sleeve 517 and is in communication with aperture 523. The channel 535 slopes towards the aperture 523 such that powder entering into the channel 535 will flow towards the aperture. A vibrating mechanism 529 is provided in a wall of the build sleeve 517.

At the end of the build of the workpiece, the build platform 502 is moved up and down past the channel 535 whilst the build sleeve 517 and powder 504 are vibrated by the vibrating mechanism 529. The vibration of the powder and movement of the build platform 502 causes the powder to be pushed into channel 535 and progress down the channel to the aperture, at which point the powder exits the build sleeve 517 into a powder recovery hopper (not shown).

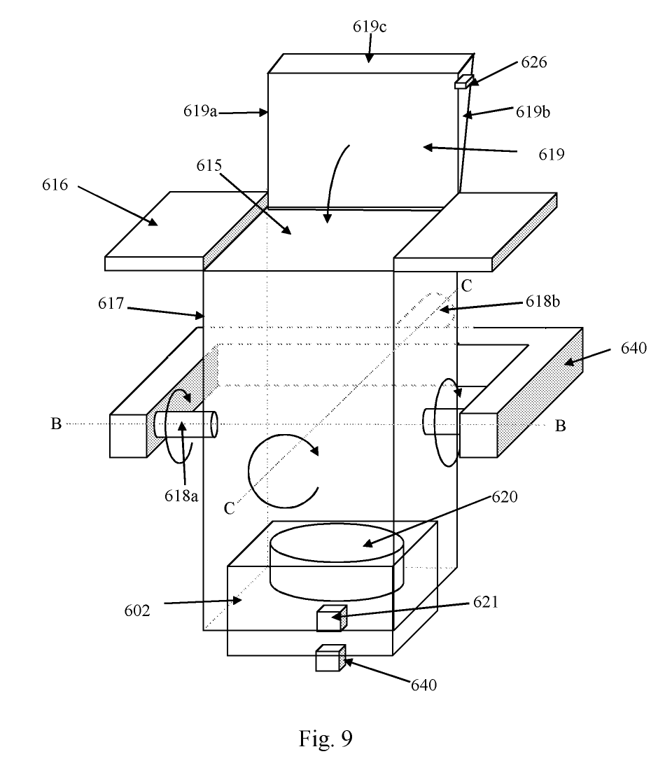

FIG. 9 shows a further embodiment of the invention. In this embodiment, like reference numerals but in the series 600 are used for features of this embodiment that correspond to features of the embodiments shown in FIGS. 1 to 8. The embodiment of FIG. 9 is similar to the embodiment shown in FIG. 4 but with an additional rotary axis C-C perpendicular to axis B-B. Shaft 618a is connected to a bracket 640, in this embodiment a U-shaped bracket, which connects shaft 618a to shaft 618b. A motor (not shown) is provided for driving shaft 618b about axis C-C. Rotation of the build sleeve 617 about two axis may allow powder to be removed from certain recesses/channels in a workpiece, which may not be achievable through rotation about a single axis. The motors for driving rotation about the axis B-B and C-C may be controlled to move the build sleeve 617 along a pre-set path after completion of the build. For example, after the end of the build, the build sleeve 617 may first be turned upside down such that opening 615 is facing downwards and then rotated is a spiral motion of gradually increasing radius.

An ultrasonic vibrating mechanism is also provided for vibrating the build platform 602 during a phase in which powder is removed, such as during execution of motion of the build sleeve 617 about the pre-set path.

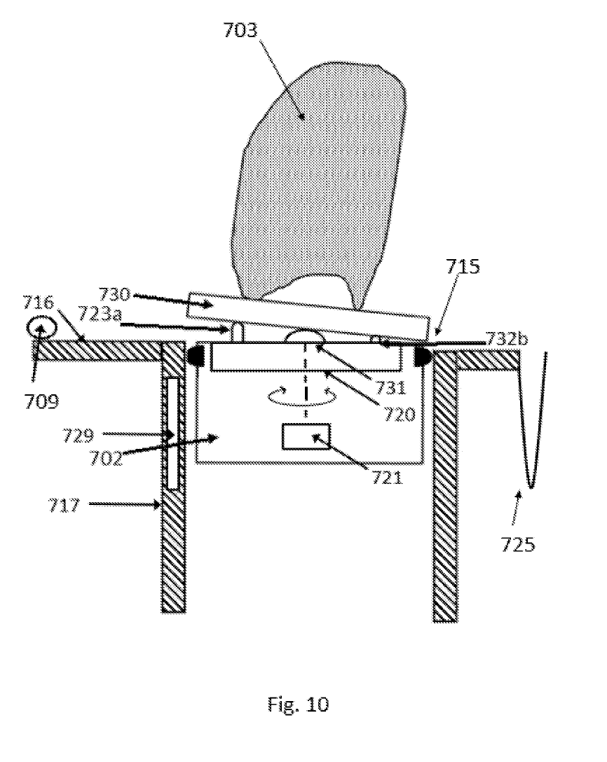

FIG. 10 shows a further embodiment of the invention. In this embodiment, like reference numerals but in the series 700 are used for features of this embodiment that correspond to features of the embodiments shown in FIGS. 1 to 9. The embodiment of FIG. 10 has a build platform 702 similar to the build platform 402 shown in FIG. 7 and comprises a tilting mechanism to which a build plate 730 is mounted that allows tilting of the build substrate 730 about a horizontal axis. The mechanism comprises a bearing, such as a spherical plain bearing 731, to which the build substrate 730 is mounted that allows titling of the build substrate 730 in any direction about the bearing 731 whilst ensuring that the build substrate 730 rotates with the rotary table 720. The titling mechanism further comprises three positioning supports (only two 732a, 732b of which are shown) that engage a lower surface of the build substrate 730 and can be actuated to protrude by a distance from the build platform 702 to set a position of the build substrate 730. The use of three positioning supports allows the build substrate 730 to be adjusted to and maintained in a continuum of tilted positions about the rotary axis of bearing 731. Variations in the distances the three positioning mechanisms 732a, 732b protrude from the build platform 702 tilt the build substrate 730 in a desired direction.

At the end of the build, the build platform 702 is slowly raised and the vibrating mechanism 729 activated. This causes collapse of the powder at opening 715 such that the powder falls under gravity onto plate 716 and can be collected in a powder recovery hopper 725. The powder recovery hopper 725 may be the same hopper as used to capture excess powder spread during layer formation. Optionally during raising of the build platform 702 and/or once the build platform 702 has been raised, the build substrate 730 is tilted and the table 720 may be rotated to release powder from recesses in the workpiece 703. The wiper 709 may be used to push any powder that remains on the plate 716 into the powder recovery hopper 725. The build platform 702 may be raised to a level which allows all the unfused build powder to travel or flow onto plate 716 by the action of the vibrating and/or tilting mechanisms.

In other embodiments the tilting mechanism may be omitted and unfused build powder may travel or flow onto plate 716 by action of the vibration mechanism 729. In still other embodiments the vibrating mechanism may be omitted and unfused build powder may travel or flow onto plate 716 by action of the tilting mechanism.

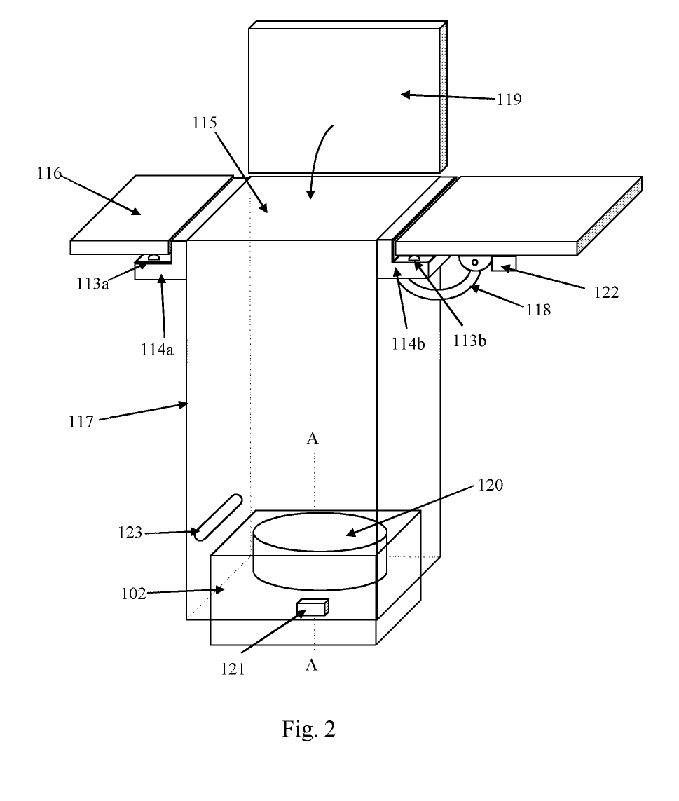

It will be understood that alterations and modifications can be made to the above described embodiments without departing from the invention as defined in the claims. For example, features of different embodiments may be used in combination, such as use of a vibrating mechanism in the embodiments described with reference to FIGS. 1 to 5 or the tiltable substrate plate shown in FIG. 6 in the other embodiments. Furthermore, features of the embodiments may be omitted without departing from the scope of the invention as defined herein. For example, the use of a vibrating mechanism in a side wall of the build sleeve to provide directionality to the powder flow may be used without the titling substrate 430 or sloping channel 535 described in FIGS. 7 and 8. A channel may be used in the embodiment of FIGS. 1 and 2 to direct powder towards the aperture 123 during tilting of the build sleeve 117. The build sleeve of the first embodiment may be titled about two perpendicular axis to encourage powder to be released from the workpiece and flow out of aperture 123.

1-27. (canceled)

28. A powder bed fusion apparatus in which selected areas of a powder bed are solidified in a layer-by-layer manner to form a workpiece, the powder bed fusion apparatus comprising a build chamber for maintaining an inert atmosphere or (partial) vacuum, a build sleeve located within the build chamber, a build platform movable in the build sleeve, the build platform for supporting a build substrate on which the object is built and a powder bed, a powder applicator for forming powder layers of the powder bed, a radiation device for generating and steering a radiation beam across a surface of the powder bed to solidify areas of each layer, and a tilting mechanism for tilting the build substrate with respect to the build sleeve such that the powder is freed from the object, the tilting mechanism arranged for tilting the build substrate when the build substrate is in a raised position above a top of the build sleeve.

29. A powder bed fusion apparatus according to claim 28 comprising a controller configured to raise the build platform at the end of a build to locate the build substrate at the top of the build sleeve and for tilting the build substrate with the tilting mechanism.

30. A powder bed fusion apparatus according to claim 28 wherein the controller is configured to rotate the build platform.

31. A powder bed fusion apparatus according to claim 28 wherein the controller is configured to rotate the build platform when the build platform is driven upwards and/or located at the top of the build sleeve.

32. A powder bed fusion apparatus according to claim 28 wherein the powder bed fusion apparatus comprises a vibration mechanism for vibrating the build platform.

33. A powder bed fusion apparatus according to claim 32 wherein the controller is configured for controlling movement of the build platform and the vibration mechanism such that the build platform is driven upwards in conjunction with vibrating the build platform.

34. A powder bed fusion apparatus according to claim 32 wherein the controller is configured to control the vibration mechanism such that an acoustic radiation force causes preferential movement of powder to a side of the build platform.

35. A powder bed fusion apparatus according to claim 28 comprising a build plate surrounding the build sleeve and the tilting mechanism is arranged for tilting the build substrate above a plane of the build plate such that powder freed from the object is deposited onto the build plate.

36. A powder bed fusion apparatus according to claim 35 wherein the tilting mechanism is arranged to tilt the build substrate such that gravity causes powder freed from the object to move to the build plate.

37. A powder bed fusion apparatus according to claim 36 comprising a wiper for forming layers of powder of the powder bed and the controller is configured to operate the wiper such that the wiper pushes powder freed from the object and on the build plate into a powder recovery channel of the powder bed fusion apparatus.

38. A powder bed fusion apparatus according to claim 37 comprising a powder recovery hopper, wherein the powder recovery channel leads to the powder recovery hopper.

39. A powder bed fusion apparatus according to claim 28 wherein the build platform is provided with at least one seal to seal a gap between the build platform and the build sleeve.

40. A powder bed fusion apparatus according to claim 28 wherein the tilting mechanism comprises supports for engaging with the build substrate, the supports movable to tilt the build substrate.

41. A powder bed fusion apparatus according to claim 28 wherein the tilting mechanism is arranged to tilt the build substrate about a horizontal axis.

42. A powder bed fusion apparatus according to claim 28 wherein the tilting mechanism is arranged in use to move at least part of the build substrate away from the build platform.

43. A powder bed fusion apparatus in which selected areas of a powder bed are solidified in a layer-by-layer manner to form a workpiece, the powder bed fusion apparatus comprising a build chamber for maintaining an inert atmosphere or (partial) vacuum, a build sleeve located within the build chamber, a build platform movable in the build sleeve, the build platform for supporting a build substrate on which the object is built and a powder bed, a powder applicator for forming powder layers of the powder bed, a radiation device for generating and steering a radiation beam across a surface of the powder bed to solidify areas of each layer, and a rotation mechanism for rotating the build substrate with respect to the build sleeve, the rotation mechanism arranged for rotating the build substrate when the build substrate is in a raised position above the top of the build sleeve.

44. A powder bed fusion apparatus according to claim 43 wherein the rotation mechanism is arranged to rotate the build substrate about a vertical axis.

45. A powder bed fusion apparatus according to claim 43 wherein the rotation mechanism to rotate the build substrate about a horizontal axis.
